(19) United States
(12) Patent Application Publication
(10) Pub. No.: US 2017/0128838 A1
(43) Pub. Date: May 11, 2017

(54) APPLICATION TESTING WITH EXPERIMENTAL LAYERS

(71) Applicant: Google Inc., Mountain View, CA (US)

(72) Inventors: John Burge, Santa Clara, CA (US); Benjamin Frenkel, Santa Clara, CA (US)

(21) Appl. No.: 14/936,427

(22) Filed: Nov. 9, 2015

(51) Int. Cl. A63F 13/79; A63F 13/31; H04L 29/06

(52) U.S. Cl. CPC A63F 13/79; H04L 67/38; A63F 13/31

(57) ABSTRACT

A method of testing an application by variably adjusting parameters in executed instances of the application includes receiving data that represents two or more experiments, each experiment comprising at least one variation of values for one or more adjustable parameters in the application, assigning unique user identifiers (IDs) to users of the application, receiving, via a network, a request for parameter values from a computing device that is running an instance of the application, the request including a first user ID, determining whether the instance of the application is a participant in a variation group or a control group in each of the two or more experiments based on a function, per experiment, applied to the first user ID, and transmitting, to the computing device via the network, parameter values based on the participant determination.

### BACKGROUND

Applications, for example, games, may include various parameters that may be fine-tuned to improve performance of the application according to different metrics. For example, in a game that requires solving a series of puzzles, one parameter could be how many puzzles a user must solve before that user can increase in level. If the game requires too few solved puzzles to advance, a player might level up in the game too quickly and easily to provide a satisfying challenge. On the other hand, if the game requires too many puzzles to be solved, advancing in levels may be too slow or hard for the player to enjoy playing the game. Both cases may result in people spending less money in the game and/or less time playing the game.

### BRIEF SUMMARY

According to an embodiment of the disclosed subject matter, a method of testing an application by variably adjusting parameters in executed instances of the application may include receiving data that represents two or more experiments, each experiment including at least one variation of values for one or more adjustable parameters in the application, assigning unique user identifiers (IDs) to users of the application, receiving, via a network, a request for parameter values from a computing device that is running an instance of the application, the request including a first user ID, determining whether the instance of the application is a participant in a variation group or a control group in each of the two or more experiments based on a function, per experiment, applied to the first user ID, and transmitting, to the computing device via the network, parameter values based on the participant determination.

According to another embodiment of the disclosed subject matter, a system to test an application by variably adjusting parameters in executed instances of the application may include an experiment server configured to receive data that defines experiments, a parameter server configured to transmit parameter values to an executed instance of the application based on at least two experiment definitions, a statistics server configured to receive metrics data from the executed instance of the application that is applying the transmitted parameter values, and an analytics pipeline configured to analyze the metrics data and output an analysis result.

According to another embodiment of the disclosed subject matter, a non-transitory machine-readable storage medium storing instructions that, when executed, cause a data processing system to test an application by variably adjusting parameters in executed instances of the application by performing operations, including receiving data that defines two or more experimental layers, each experimental layer being defined to include at least one variation value, the at least one variation value being defined to adjust one or more parameters in the application that are not adjusted by any other experimental layer, determining whether an executed instance of the application will receive a variation value or a default value for each experimental layer, and transmitting parameter values to the executed instance of the application based on the determination.

According to an embodiment of the disclosed subject matter, means for receiving data that represents two or more experiments, each experiment including at least one variation of values for one or more adjustable parameters in the application, assigning unique user identifiers (IDs) to users of the application, receiving, via a network, a request for parameter values from a computing device that is running an instance of the application, the request including a first user ID, determining whether the instance of the application is a participant in a variation group or a control group in each of the two or more experiments based on a function, per experiment, applied to the first user ID, and transmitting, to the computing device via the network, parameter values based on the participant determination are provided.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a system according to an embodiment of the disclosed subject matter.

FIG. 2 shows a block diagram of an application and a framework according to an embodiment of the disclosed subject matter.

FIG. 3 shows a flowchart of a process according to an embodiment of the disclosed subject matter.

FIG. 4 shows a table of an example experiment definition according to an embodiment of the disclosed subject matter.

FIG. 5 shows a table of example parameter values according to an embodiment of the disclosed subject matter.

FIG. 6A shows a portion of example pseudo-code according to an embodiment of the disclosed subject matter.

FIG. 6B shows a modified portion of example pseudo-code according to an embodiment of the disclosed subject matter.

FIG. 7 shows a portion of functions in example pseudo-code according to an embodiment of the disclosed subject matter.

FIG. 8 shows a computing device according to an embodiment of the disclosed subject matter.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing the subject disclosure.

Some portions of the detailed description are presented in terms of algorithms and symbolic representations of operations on data bits within a computer memory. These algorithmic descriptions and representations are commonly used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “analyzing,” “testing,” “identifying,” “sending,” “totaling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Before providing a detailed discussion of the figures, a brief overview will be given to guide the reader. In some situations a software application may have a large user base that enables a developer to run ‘experiments’ to optimize parameters in the application. The experiments may include, for example, adjusting a parameter in the application for a subset of users for a given amount of time. If the user base is large enough, the developer may save time and expenses by simultaneously running multiple experiments on isolated subsets of users such that no user will be in more than one experiment at a time. The developer could therefore examine and compare metrics obtained from across the spread of experiments to determine which parameter settings achieve optimal results for multiple parameters simultaneously.

However, in some cases the user base may not be large enough to support the multiple, isolated experiments that a larger user base could support. In a simplified example, a developer may prefer that a minimum of 100 users test a given variation of a parameter setting. However, the developer may have a user base of only 200 and need to run experiments to optimize three different parameters. In this case the developer would be forced to run multiple consecutive experiments testing each variation one at a time, which may be costly in terms of time and resources.

Embodiments of the disclosed subject matter provide what will be referred to as a framework of experimental layers. The term ‘experimental layers’ may be used to refer to a plurality of experiments that are intended to be executed on an application. A single user having a unique identifier (ID) may participate as a member of a variation group or a control group in two or more of the disclosed experimental layers simultaneously. Each experimental layer can contain multiple variations that adjust one or more parameters of the application, and each experiment may be defined based on rules that avoid or minimize a cross-talk or interference effect with other experimental layers.

By using the disclosed experimental layers, a developer may increase the number of simultaneous experiment runs that are possible, thereby saving valuable time and resources and improving the rate at which optimal or desired parameter settings are discovered. As a result, an amount of time that the application is presented in an optimized condition may be increased. Also, the disclosed embodiments may increase a likelihood of taking advantage of limited windows of opportunity to achieve application goals, such as improving engagement, conversions, or retention.

The following description is based on embodiments of the disclosed subject matter and should not be taken as limiting the claims with regard to alternative embodiments that are not explicitly described herein.

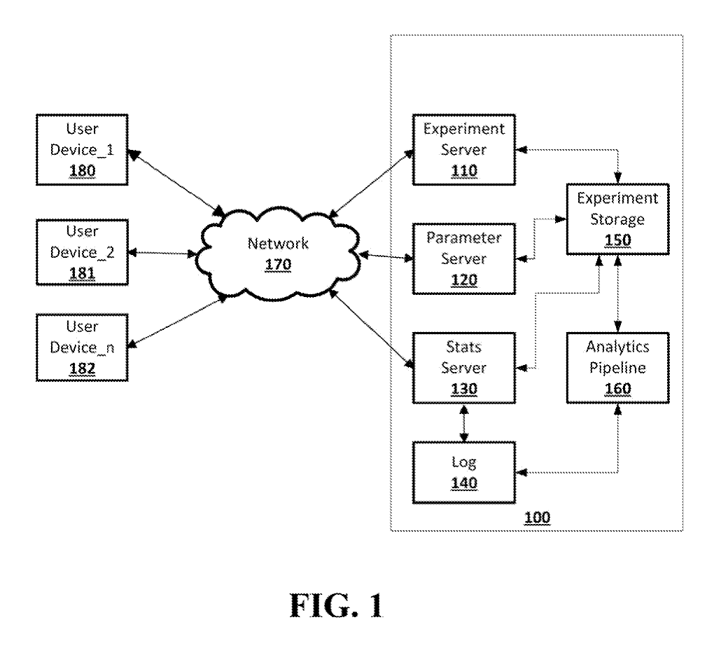

Turning now to a more detailed discussion in conjunction with the attached figures, the schematic diagram of FIG. 1 shows an embodiment of a system for implementing the disclosed subject matter. A framework 100 that provides experimental layers according to the disclosed embodiments may include an experiment server 110, a parameter server 120, a statistics server 130, a log database 140, an experiment storage database 150, and an analytics pipeline 160. The experiment server 110 may provide an interface for developers to enter data that define experiments and may provide services for managing that data. The parameter server 120 may provide an interface for communicating with applications, e.g., to transmit parameter values, and may provide services for managing the parameter values. The experiment storage database 150 may store the experiment data and the parameter data that are accessed by the experiment server 110 and parameter server 120.

The statistics server 130 may provide an interface for receiving statistical data and metrics from applications and may store the data in the log database 140. The analytics pipeline 160 may provide an analytical service that analyzes the log data and stores data that indicates analysis results in the experiment storage database 150, in association with corresponding experiment data. Such analysis may occur, for example, on a periodic basis (e.g., monthly, weekly) or an on-going basis (e.g., real time).

The framework 100 may be implemented in a single computing device, such as a server, or may be implemented in two or more separate, interconnected computing devices. For example, in one embodiment, the experiment server 110 may be implemented separate from the parameter server 120. The experiment server 110 may be implemented using a server configured for a low queries-per-second (QPS) load, while the parameter server 120 may be implemented using a server configured for a high QPS load. In this layout, the framework 100 may provide the developer with access to an interface for adjusting experiments, deleting experiments, or the like, on a computing device that is separate from the computing device that handles parameters requests.

The parameter server 120 may experience significantly higher queries-per-second (QPS) compared to the experiment server 110 due to multiple applications communicating with the framework, particularly as the number of developers using the system increases and the number of applications being tested increases. The layout that includes separate servers for experiment definitions and experiment parameters may reliably provide developers with high speed access to adjust experiments in real time if necessary since the experiment server 110 may be operating under a relatively smaller workload than the parameter server 120. The separation may be extended to include multiple experiment servers 110 and multiple parameters servers 120.

User devices 180-182 may run applications to be tested using the disclosed experimental layers framework 100. User devices 180-182 may connect to the framework 100 via a network 170, such as, for example a local-area network (LAN), a telephone network, a mobile communications network, a wide-area network (WAN), the Internet, or similar communications system. User devices 180-182 may be any type of computing device including without limitation cell phones, smart phones, hand-held computers, tablets, wearable computing devices, navigation devices, appliances, vehicles, smart TVs, set-top boxes, server computers, desktop computers, laptop computers, game consoles, mobile communications devices, or similar computing devices.

The disclosed framework 100 may be configured to provide an interface to allow a developer to submit data to the framework 100. For example, the developer may use a browser or a customized application to login to the experiment server 110 and enter the data. The data may, among other things, define the bounds of the experiments, specify user classes or categories that will participate in the experiments, and set values for parameters that participants receive when they execute the application.

The experiment definitions may be subject to no limitations or subject to limitations, for example, a limitation of exclusive definition. In the case of exclusive definition, no single parameter may be adjusted by more than one experiment. The framework 100 may enforce experiment limitations such as exclusive definition as a system rule. For example, if a developer attempts to submit data for an experiment that attempts to test a parameter that is already being tested by another experiment for a given application, the experiment server 110 may be configured to enforce an exclusive definition rule and thus may provide a rejection notice and not record the data.

Exclusive experiment definitions may help improve the accuracy of testing results when users participate in more than one experiment at a time by providing a measure of insulation between experiments and mitigating against cross-talk or interference. Here, interference may refer to a situation in which a first experiment is attempting to adjust a parameter that a second experiment has already adjusted. Cross-talk may refer to an impact of one experiment upon another. Either scenario may reduce the accuracy of conclusions based on the testing results. Ideally, an instance of an application can participate as a control group member in one experiment and as a variation group member in another experiment simultaneously without either experiment effecting the outcome of the other.

Within the application, markers inserted in the code, referred to as experiment flags, identify adjustable parameters that receive values (i.e., variation or default) from the framework 100. Upon execution of the application, the application communicates with the parameter server 120 to receive test values that are used by the application in place of the experiment flags.

A unique user identifier (ID) may be assigned to any user that executes an application that communicates with the framework 100. The user ID may be assigned, for example, by the framework 100 itself, by an ancillary system, such as a store or app ecosystem, or may be otherwise created and identified based on other data such as device identifiers or metadata from the device operating system. Based on the user's ID, the framework 100 may determine in which capacity an executed instance of the application participates in any active experiment, that is, which values, variation or default, the instance of the application will receive from the framework 100. For example, the instance of the application may participate in variation groups in two experiments, and therefore have two different sets of experiment flags that receive variation values from the parameter server 120. For all other flags in the application that do not receive a variation value, the parameter server 120 may provide respective default values or a signal indicating that the application should refer to locally stored default values. That is, for these values either no experiment is active, or if any experiment is active the instance of the application will be participating as a control group member therein.

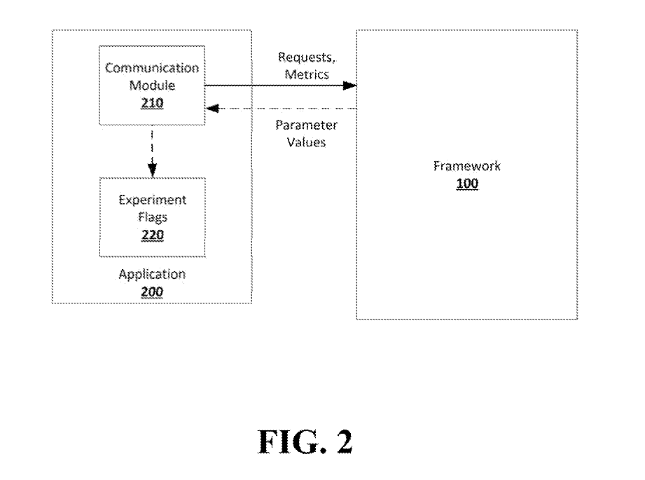

FIG. 2 shows a conceptual block diagram of the cooperation of the application 200 and the framework 100. Application 200 may include a communication module 210 configured to communicate metrics and requests to the framework 100, and experiment flags 220 configured to receive values for parameters within the application 200.

Referring to FIGS. 1 and 2, when a user executes application 200 on a user device, e.g., user device 180, the communications module 210 connects with the framework 100 via the network 170. The communications module 210 communicates initial data to the framework 100. The parameter server 120 processes the received data and determines parameter values to transmit back to the application 200.

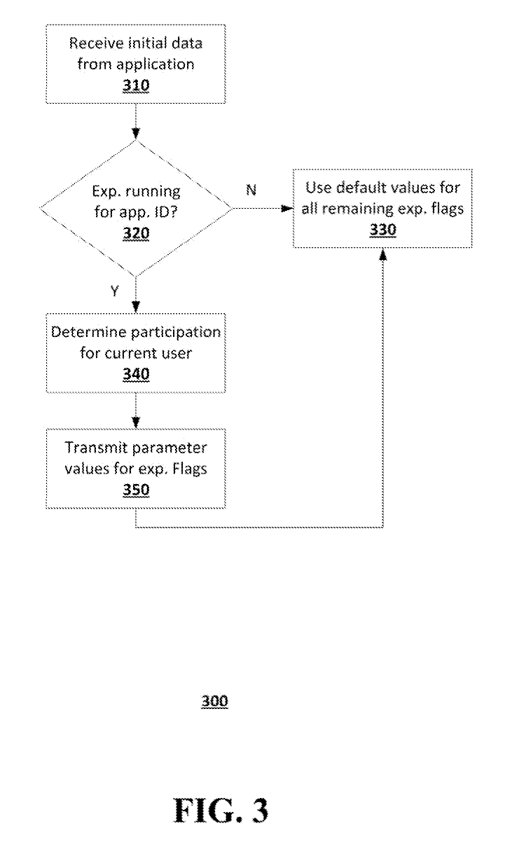

FIG. 3 shows a flowchart 300 illustrating a process that the parameter server 120 may implement to determine parameter values according to one embodiment. Referring to FIGS. 1 and 3, at operation 310 the framework 100 receives initial data from the application 200. The initial data may include, for example, a user ID, an application ID, initial metrics data, and/or a request for parameters. At operation 320 the parameter server 120 determines whether the framework 100 is currently running any active experiments related to the application based on the application ID received in the initial data. For example, the parameter server 120 may search the experiment storage 150 for any experiments having an active status associated with the received application ID. When the framework 100 is not currently running any active status experiments for the application 200, the parameter server 120 may transmit either default parameter values or a signal instructing the application 200 to use locally stored default values for all experiment flag parameters in the application 200 at operation 330.

The parameter server 120 may also determine whether the requesting instance of the application 200 is installed on a device owned by a user that is within a target class or category of users for an experiment based on the initial data or, similarly, whether the device on which it is installed is within a particular class or category. For example, an experiment may be defined as only applicable to a particular operating system, only certain versions of one or more operating systems, or the like.

When the parameter server 120 determines that the framework 100 is currently running one or more active status experiments associated with the received application ID and the current instance of the requesting application 200 is within a target class, the parameter server 120 determines whether the application 200 should participate in a variation group or control group in any applicable active experiments at operation 340. To do this, the parameter server 120 may use one or more functions to sort the user into one or more variation ‘buckets’ in the experimental layers based on the user's ID. In one embodiment, the function may comprise applying a mod operation to the user's ID, where the user ID is in a numerical format.

For example, a developer may set a participation target of 33% of all users for an experiment variation. Accordingly, the parameter server 120 may apply a mod 3 function the user ID, which will result in one of three different values. Each value may be assigned to a bucket, where the bucket is associated with either an experiment variation group or a control group. In this example, any user ID mod 3 that results in the value ‘2’ may be identified as participants in one of two experiment variations. In other words:
Function(userID)=0 then control group
Function(userID)=1 then variation group #1
Function(userID)=2 then variation group #2

In another embodiment, the parameter server 120 may further apply either a randomizing function or a deterministic function to alter the user ID before identifying which bucket the user is in. Each randomizing function or deterministic function applied may correspond to or define placement in a unique experimental layer. For example, the parameter server 120 may apply four different deterministic hash functions to the user's ID, and in each case perform a mod operation on the hashed value. The four hash functions in this embodiment may represent four experimental layers. Thus, in the first layer, using the first hash function, following a mod operation a user may be placed in bucket ‘0’. This may result in the user functioning as a control group member and receiving a signal to use default values for the corresponding parameters. However, in the second layer, using a second hash function, a user may be placed in bucket ‘2’, which may result in the user participating in the second layer experiment variation group #2 and receiving a variation value, and so on.

At least one advantage of the use of experimental layers is that user groups that participate in an experiment may be dispersed among the full population, further lowering the chance of a final analysis result being impacted by interference among multiple experiments. For example, even if the experiments are exclusively defined, interference may still occur between certain experiments when different variables effect a same outcome or from indirect ripple effects. Such phenomenon may be unpredictable, or even undetectable, particularly as the number of active experiments increases. However, implementing each layer with a unique function will result in a unique dispersal pattern for each experiment and dampen the effects of interference.

Referring back to FIGS. 1 and 3, at operation 350 the parameter server 120 transmits parameter values corresponding to each experiment variation that the current instance of the application is a participant in. At operation 330 the parameter server 120 transmits an instruction to use default values for any experiment flags that have not received parameter values.

An embodiment of the disclosed framework 100 will now be described in a run-through example scenario of testing a game application and receiving the analysis results. This scenario is provided merely to illustrate various features and aid in understanding the disclosed subject matter. This scenario is not intended to limit the application of the disclosed subject matter in any way to the specific details of this particular example.

In this example scenario, a developer of a game application (e.g., “Game Z”) with a current user base of 1000 players desires to test, among other things: a) whether six zombies or nine zombies should guard an exit against a player escape from a first level of the game, b) whether 100 hit points or 200 hit points is appropriate for a zombie queen in level three, and c) whether the player should discover 15 milliliters of zombie antidote or 19 milliliters of zombie antidote behind a bookshelf at the start of level five. In this case, the developer is testing for player retention and intends to use the framework 100 to track metrics that capture player progress beyond each testing point in the game. Therefore, the developer of Game Z defines three experiments—A, B, and C—each having one variation value and one control value.

Generally, to define an experiment a developer must submit data to the framework 100. The data may include any or all of the following: an experiment identifier (ID), an experiment status (active/inactive), a time window during which the experiment will remain active, a target number of users (e.g., a percent value or a hard number), and a user target factor (e.g., all mobile users, all web-based users, or all users of a specific version (e.g., 2.1) of the application). One of ordinary skill in the art will appreciate that the experiment definition is not limited to the above listed values but may also include additional, ancillary elements, such as those required for implementation in a given system or for providing security features or other functionality.

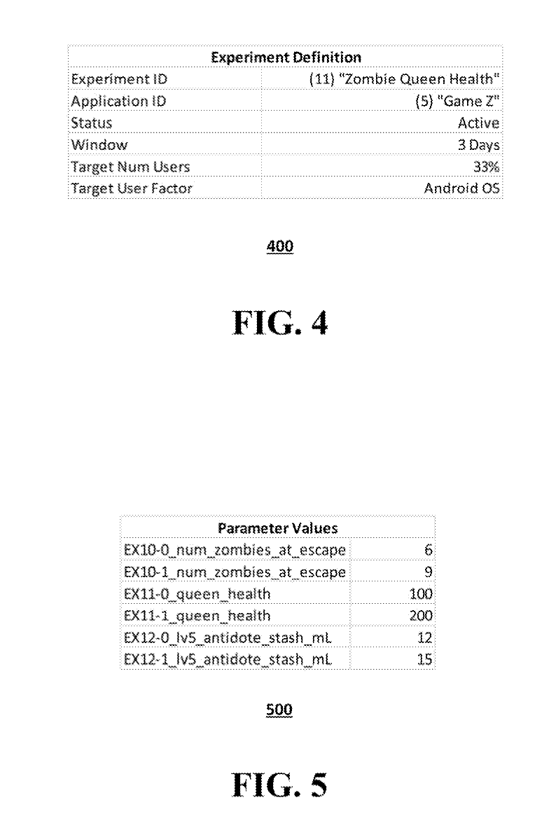

FIG. 4 is a table 400 illustrating an example experiment definition for Game Z. The developer submits the experiment definitions to the experiment server 110, for example, by logging into an interface and filling in a form, by uploading data, by sending an email, or by some other form of electronic data transmission. The experiment server 110 stores the experiment definition data in the experiment storage 150.

The developer will also submit variation values for each experiment. The variation values will be tested by users participating in the experiment. The developer may also optionally submit control values. In some applications, default values will be stored locally in the application code.

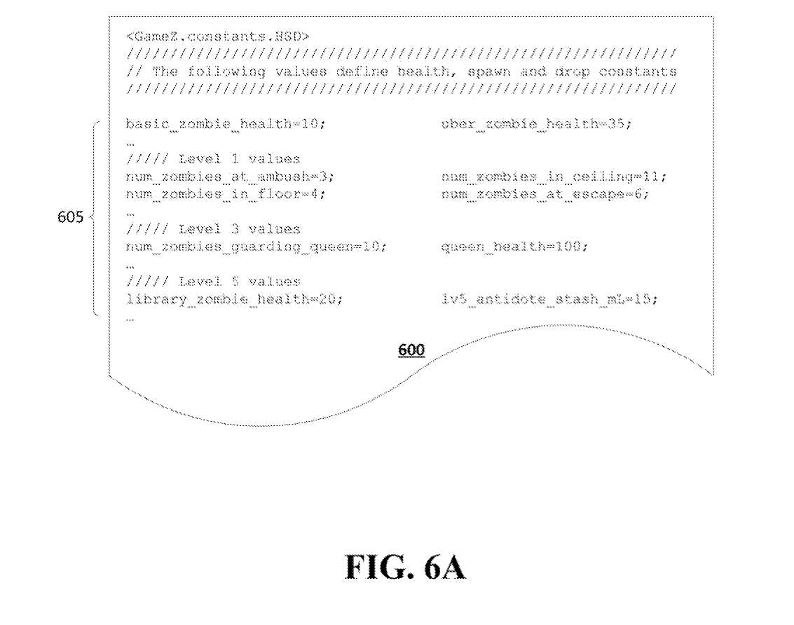

FIG. 5 is a table 500 illustrating example variation and control parameter values for Game Z. In this example, a naming convention is used for each parameter value to indicate which experiment the parameter value is applicable to (e.g., “EX10”) and whether the value is a control value or a variation value (e.g., “−0” or “−1”). The experiment server 110 may store the parameter values in the experiment storage 150, for example, in a database, or as a set of key/value pairs, where the ‘key’ is the name of an experiment flag in the application and the ‘value’ is the value taken by the experiment flag for the participating users, or in any other associative data structure that links an experiment flag with a value as set by the developer.

Generally, a developer intending to use the disclosed framework 100 may or may not have initially written their application code to comply with the framework 100. In this scenario, for illustrative purposes the developer of Game Z did not initially write the game code to fully comply with the framework 100. Therefore, prior to using the framework 100, the Game Z code must be modified to include: 1) one or more experiment flags that correspond to parameters that may be tested, and 2) communication functions required to communicate metric data to the framework 100 and to request parameter values from the framework 100.

The developer may edit the code to include the experiment flags. The communication functions may be included, for example, manually by the developer or automatically by a tool provided by the framework 100, e.g., by providing a software development kit (SDK) installation process for a given operating system. The framework 100 may be configured to verify that any application using the framework 100 includes at least these two components of experiment flags and communications functions.

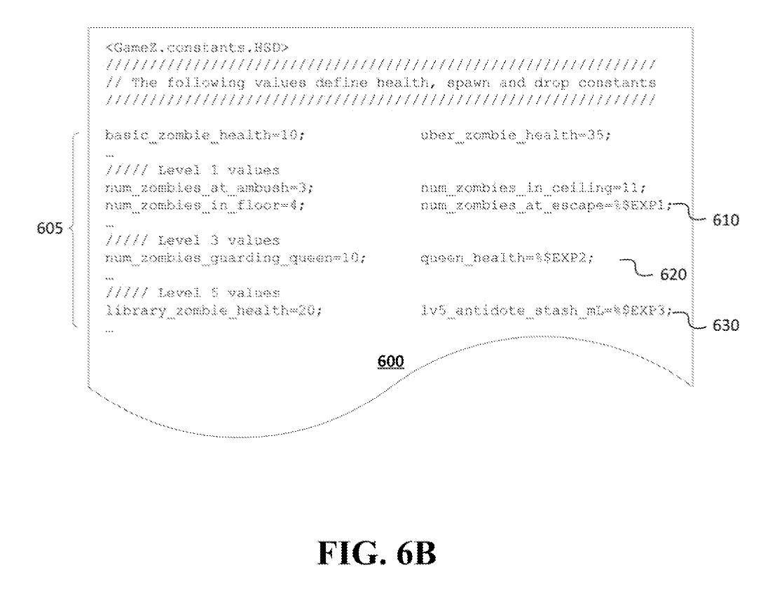

FIG. 6A shows a portion of an illustrative example of a pseudo-code Game Z file 600 that the developer prepared. File 600 contains definitions for various parameters 605 in the game. It should be understood that file 600 and any other pseudo-code used herein is merely an informal representation of code presented for illustrative purposes and does not conform to any particular programming language, nor is it intending to be limiting in any way to a specific programming language. One of ordinary skill in the art can understand the concept of the functions described herein and implement them in accordance with the conventions and rules of any given programming language, system or the like.

In order to prepare the Game Z application to work with framework 100, each parameter that the developer desires to test should be modified to refer to a framework 100 experiment flag. In this illustration, the developer intends to test at least three different parameters, i.e., “num_zombies_at_escape,” “queen_health,” and “lv5_antidote_stash_mL.” Therefore, as shown in FIG. 6B, the developer has modified the code to include experiment flags 610, 620, and 630 referred to by each parameter to be tested. As will be seen further below, the experiment flags 610, 620, and 630, function similar to placeholders for data values that will be obtained from the framework 100 upon execution of the application.

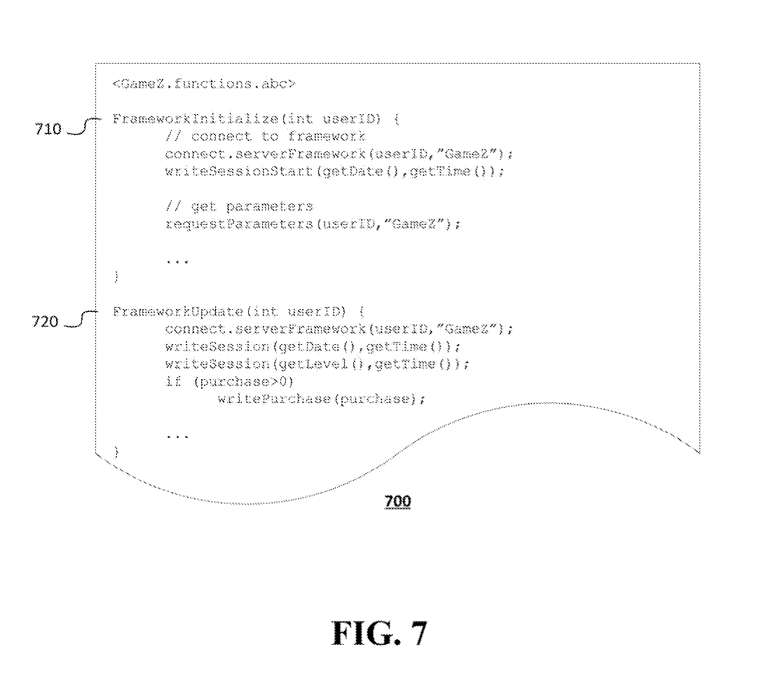

Referring to FIG. 7, a portion of an example pseudo-code file 700 contains functions that operate as a communications module for communicating metrics to the framework 100 and requesting parameter data from the framework 100. For example, the functions may include at least an initialization function 710 that connects to the framework 100, communicates data indicating a start of a session, and requests parameter data. The functions may also include an update function 720 that connects to the framework 100 and communicates initial metrics data and further communicates metrics data that is generated while the session is ongoing and when the session ends.

In the example illustrated in FIG. 7, function 720 is depicted as communicating data related to time, level in the game, and purchases. “Level” and “purchases” may be types of metrics applicable to Game Z, however, in the context of the disclosed framework 100 it should be understood that metrics may include any metric of the application and its use by the user, or any metrics that may be affected directly or indirectly by adjusting parameters in the application. Without limitation, example metrics may include amount of time spent using the application, time of day/week/year that the application is used, type of purchases completed during a session, number of purchases completed during a session, number of sessions during a given window of time, reaching a milestone or progression marker within an application, rate of progress through an application, or any custom metric. One of ordinary skill in the art will appreciate that metrics may vary greatly from application to application and the disclosed framework 100 is not limited in applicability to a single type of application or set of metrics.

Furthermore, as stated regarding the experiment flags 610, 620, and 630, the functions 710, 720 are provided merely as pseudo-code illustrations and do not adhere to any specific programming language. One of ordinary skill in the art could implement one or more functions 710, 720 to operate as a communications module for communicating requests and metrics data in any suitable programming language, code, script, or functionally similar alternative.

To continue the example Game Z scenario, recall that Game Z currently has 1000 users and the developer desires to test at least one variation of each of experiments A, B, and C, each on 33% of the user base. Referring to FIGS. 1, 2, and 6B, when a Game Z player starts an instance of the game (i.e., application 200) on a mobile phone (i.e., user device_1 180), the phone will transmit an initial communication to the framework 100 via the network 170. The initial communication will include at least the user ID of the player, the application ID of Game Z, initial metric values (e.g., time that the user began playing the game, type of device, operating system, etc.), and a request for parameter values for experiment flags 610, 620, and 630.

When the framework 100 receives the initial communication, the stats server 130 logs the initial metric values in the data log 140, and the parameter server 120 determines in which capacity the instance of the Game Z will participate in each experiment based on the application ID, user ID and experiment definition data stored in the experiment storage 150. The stats server 130 may also log any customized metric data, for example, as required based on an experiment definition data stored in the experiment storage 150.

The parameter server 120 executes the process disclosed above and shown in flowchart 300 in FIG. 3, or some permutation thereof, resulting in the framework 100 sending parameter values back to the instance of the application 200 running on the mobile phone. For example, the framework 100 may determine, based on the initial data, that the instance of the application is running on a target operating system and therefore is part of the target class. Since there are three active experiments, the parameter server may therefore apply three different functions to the user ID, resulting in the user participating in the variation groups in experiments A and B, and the control group in experiment C.

Referring to FIGS. 5 and 6B, since the application falls in the variation groups in experiments A and B, and the control group in experiment C, it will receive the following example parameter values:
610%$EXP1=9, therefore, num_zombies_at_escape=9
620%$EXP2=200, therefore, queen_health=200
630%$EXP3=12, therefore, lv 5 antidote_stash_mL=12

The game will proceed with these values, and the player will automatically be participating in three experiments simultaneously. The player may be completely unaware of his/her participation in the experiments and play the game as normal.

While the game is running, the application 200 communicates session data to the framework 100. The session data may be communicated to the framework 100 one or more additional times before the game stops running Session data may include, for example, various metric data such as the time, milestones reached within the game, purchases made, or any custom data. The stats server 130 may record the session data in the log database 140.

The analytics pipeline 160 may process the data stored in the log database to provide analytical results for the experiments. Analytical results may include, for example, how many users participated in each experiment, how much time each user spent in the application, how many purchases occurred in each experiment, whether the data for any variation statistically significantly diverged from the experiment's control group, and other types of analysis. When users participate in multiple experiments simultaneously, the analytics pipeline 160 may provide additional analysis to calculate offsets due to interference that may be inferred or is identifiable, for example, due to trends, anomalies, correlations, or the like that appear in the data. The analytical results may be stored in the experiment storage 150 and may be accessible for the developer to access and consider.

Based on the results, the developer may determine which parameter values result in greater player retention. For example, the results may show that over the three day test period significantly more players returned to continue playing the game beyond the zombie queen encounter when the parameter representing the zombie queen's health value was set to 200 as opposed to 100. Accordingly, the developer may change the default value of the zombie queen's health parameter from 100 to 200 and improve player retention for Game Z.

Thus, by using the disclosed framework 100 the developer may fine tune multiple parameters in an application at an improved rate. The framework 100 may provide actionable results and may function as a tool for making changes that advance the application toward any of multiple goals that the developer may be pursuing.

In situations in which the systems discussed here may collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a system as disclosed herein.

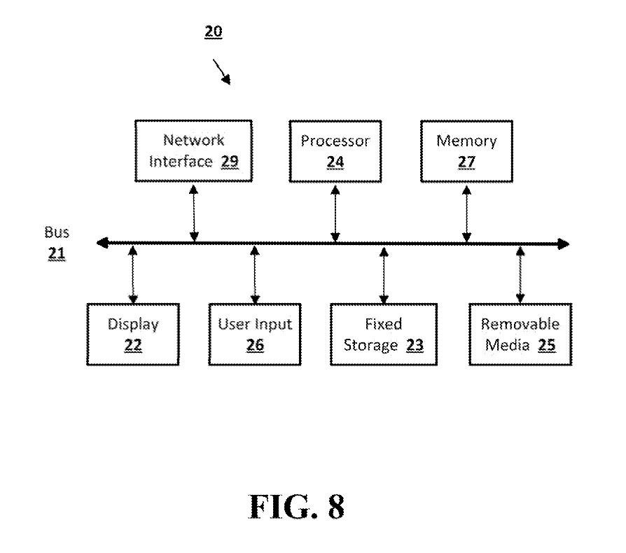

Embodiments of the presently disclosed subject matter may be implemented in and used with a variety of component and network architectures. FIG. 8 is an example computing device 20 suitable for implementing embodiments of the presently disclosed subject matter. The device 20 may be, for example, a desktop or laptop computer, or a mobile computing device such as a smart phone, tablet, or the like. The device 20 may be configured to operate as the framework 100 or as a component of the framework 100, for example, the experiment server 110, the parameter server 120, or the like.

The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth®, near-field, and the like. For example, the network interface 29 may allow the computer to communicate with other computers via one or more local, wide-area, or other communication networks, as described in further detail below.

Many other devices or components (not shown) may be connected in a similar manner (e.g., document scanners, digital cameras and so on). Conversely, all of the components shown in FIG. 8 need not be present to practice the present disclosure. The components can be interconnected in different ways from that shown. The operation of a computer such as that shown in FIG. 8 is readily known in the art and is not discussed in detail in this application. Code to implement the present disclosure can be stored in computer-readable storage media such as one or more of the memory 27, fixed storage 23, removable media 25, or on a remote storage location.

The aforementioned systems/circuits/components have been described with respect to interaction between several components/blocks. A person of ordinary skill in the art would appreciate that such systems/circuits and components/blocks can include those components or specified sub-components, some of the specified components or sub-components, and/or additional components, according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of ordinary skill in the art.

While, for purposes of simplicity of explanation, some of the disclosed methodologies are shown and described as a series of acts within the context of various block diagrams and flowcharts, it is to be understood and appreciated that embodiments of the disclosure are not limited by the order of operations, as some operations may occur in different orders and/or concurrently with other operations from that shown and described herein. For example, those skilled in the art will understand and appreciate that a methodology can alternatively be represented as a series of interrelated states or events, such as in a state diagram. Moreover, not all illustrated operations may be required to implement a methodology in accordance with the disclosed subject matter. Additionally, it is to be further appreciated that the methodologies disclosed hereinafter and throughout this disclosure are capable of being stored on an article of manufacture to facilitate transporting and transferring such methodologies to computers. The term article of manufacture, as used herein, is intended to encompass a computer program accessible from any computer-readable device or storage media.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method of testing an application by variably adjusting parameters in executed instances of the application, comprising:
receiving data that represents two or more experiments, each experiment comprising at least one variation of values for one or more adjustable parameters in the application;
assigning unique user identifiers (IDs) to users of the application;
receiving, via a network, a request for parameter values from a computing device that is running an instance of the application, the request including a first user ID;
determining whether the instance of the application is a participant in a variation group or a control group in each of the two or more experiments based on a function, per experiment, applied to the first user ID; and
transmitting, to the computing device via the network, parameter values based on the participant determination.

2. The method of claim 1, further comprising receiving metrics data from the computing device that is running the instance of the application using the transmitted parameter values.

3. The method of claim 1, wherein transmitting the parameter values comprises:
transmitting a variation of a value for one or more of the adjustable parameters of the application; and
transmitting an instruction to use default values for all remaining adjustable parameters.

4. The method of claim 1, wherein no two experiments adjust the same parameter.

5. The method of claim 1, wherein the instance of the application is determined to be a participant in a variation group or in a control group in a first experiment based on a first function applied to the first user ID and is determined to be a participant in a variation group or control group in a second experiment based on a second function, different from the first function, applied to the first user ID.

6. The method of claim 5, wherein the first function comprises a first hash function and the second function comprises a second hash function.

7. The method of claim 6, wherein the first function and the second function further comprises a mod operation applied to the respective hashed ID.

8. The method of claim 1, further comprising receiving, via the network, metrics data from the computing device that is running the instance of the application with the transmitted parameter values applied.

9. The method of claim 8, wherein the metric values include an amount of time spent using the application while the transmitted parameter values are applied.

10. The method of claim 8, wherein the metric values include an amount of purchases made in the application while the transmitted parameter values are applied.

11. A system to test an application by variably adjusting parameters in executed instances of the application, comprising:
an experiment server configured to receive data that defines experiments;
a parameter server configured to transmit parameter values to an executed instance of the application based on at least two experiment definitions;
a statistics server configured to receive metrics data from the executed instance of the application that is applying the transmitted parameter values; and
an analytics pipeline configured to analyze the metrics data and output an analysis result.

12. The system of claim 11, wherein:
the parameter server is implemented in a computing device that is separate from the experiment server, and
the parameter server is configured to handle a high queries per second (QPS) load and the experiment server is configured to handle a low QPS load.

13. The system of claim 11, wherein each experiment definition comprises at least one variation of a value for one or more adjustable parameters in the application.

14. The system of claim 14, wherein no two experiments adjust the same parameter.

15. The system of claim 11, wherein the instance of the application is determined to be a participant in a variation group or in a control group in a first experiment based on a first function applied to the first user's ID and is determined to be a participant in a variation group or control group in a second experiment based on a second function, different from the first function, applied to the first user's ID.

16. The system of claim 15, wherein the first function comprises a first hash function and the second function comprises a second hash function.

17. The system of claim 16, wherein the first function and the second function further comprises a mod operation applied to the respective hashed ID.

18. A non-transitory machine-readable storage medium storing instructions that, when executed, cause a data processing system to test an application by variably adjusting parameters in executed instances of the application by performing operations, comprising:
receiving data that defines two or more experimental layers, each experimental layer being defined to include at least one variation value, the at least one variation value being defined to adjust one or more parameters in the application that are not adjusted by any other experimental layer;
determining whether an executed instance of the application will receive a variation value or a default value for each experimental layer; and
transmitting parameter values to the executed instance of the application based on the determination.

19. The non-transitory machine-readable storage medium of claim 18, the operations further comprising:
receiving metrics data from the computing device that is running the instance of the application and is using the transmitted parameter values.

20. The non-transitory machine-readable storage medium of claim 18, wherein the executed instance of the application is determined to receive a variation value in a given experimental layer based on a function applied to a unique user identifier (ID) associated with the executed instance of the application.

21. The non-transitory machine-readable storage medium of claim 20, wherein the function comprises a hash function and a mod operation.
